(19) United States
(12) Patent Application Publication
(10) Pub. No.: US 2003/0004912 A1
(43) Pub. Date: Jan. 2, 2003

(54) Architecture for intelligent agents and distributed platform therefor

(76) Inventors: Lalit Pant, Monroeville, PA (US); Rahul Tripathi, Pittsburgh, PA (US); Richendra Khanna, Pittsburgh, PA (US); Vineet Manohar, Monroeville, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 09/895,619

(22) Filed: Jun. 29, 2001

(51) Int. Cl. G06N 5/02

(52) U.S. Cl. 706/47

(57) ABSTRACT

Disclosed is an architecture for an intelligent agent and for a distributed platform for supporting many of such agents. Also described are scenarios wherein intelligent agents may be used.

### FIELD OF THE INVENTION

This invention relates to the field of artificial intelligence, and, in particular, to software objects commonly known as intelligent agents.

### BACKGROUND OF THE INVENTION

The web is fast evolving from being a repository of information for human consumption—the syntactic web—to something that carries much richer forms of information—the semantic web. To make optimal use of the new kind of information, a new kind of intelligent program, often referred to as an agent, is required. Systems based on agent technology will be the building blocks of the intelligent web of the future.

The World Wide Web is both a massive repository of information, and an enabler of a large number and variety of e-services. Many products and services, for example, books, airline tickets, banking, encyclopedias, auctions and trading hubs, are available on the web. Most of the information available on the web has just a few common essential characteristics:

It is unstructured

It is transmitted around in chunks called pages using a simple protocol called HTTP

These pages are marked-up in a format called Hypertext Mark-Up Language (HTML) that is geared towards presentation to human beings

HTML allows easy linking of content in one document to content in another document

The uncomplicated nature of the web content creation process, combined with the simplicity, expressiveness and power of web transport and presentation technology, has led to an explosion in the size of the web and the information available thereon. It has given an enormous number of people the ability to move around in the web using inexpensive computers and a piece of software called a browser. But now, as the web stretches to accommodate new kinds of business-related applications, some of these characteristics that make the web so attractive are starting to become a bottleneck.

One fundamental problem is that the web, in its current incarnation, is really geared towards presenting information to human beings. The default language of the web—HTML—essentially describes how the information on a web page is to be presented by a browser for consumption by a human being. However, all of the interesting, powerful interactions between computer systems in the world today happen in islands of information. As soon as information passes through a web front-end in the form of HTML, the ability of non-humans to make use of this information is decreased dramatically. The web, in its current incarnation, is not very friendly to the programs trying to access and use the vast amounts of information that it contains. Ironically, given the heterogeneity and volume of this information, it is precisely these programs that can bring out the most value from the information.

One solution to this problem is provided by XML. XML allows us to mark-up information with syntax that is meaningful in a specific domain. When this domain-specific syntax is combined with associated semantics, all of the prerequisites that are necessary for programs to really go out and make full use of the information on the web are present—thereby providing tremendous value to consumers, businesses, individuals and organizations.

A key element for communications between non-humans is something known as an ontology. Basically, an ontology is the specification of a model for the language of a domain. The main purpose of an ontology is to enable communication between programs in a way that is independent of the architecture and the implementation of the programs. The key ingredients that make up an ontology are a vocabulary of basic terms and a precise specification of what those terms means.

The concept of an ontology is a key enabler for large scale internet commerce. Even though XML goes a long way towards solving the problem with HTML, XML by itself is not enough. XML allows us to mark-up information in a domain specific manner using tags defined for that domain. But, unless programs that use this domain specific language for communication can agree on the ‘meaning’ of these tags, they can't really interact effectively. The ontology is able to bridge this gap by providing an exact specification of the meaning of domain-specific XML tags with which content is marked-up.

CommerceOne, Rosetta-Net, cXML and ebXML are examples of initiatives in this direction. The primary purpose of these initiatives is to provide global online vocabularies and ontologies for different business domains, so that programs can start communicating over the web in a much more meaningful and powerful manner.

Intelligent agents are the software programs that will be able to take advantage of the web using the defined ontologies. However, before such systems can become a reality, a powerful general-purpose technology infrastructure is required for developing and deploying agents. This patent discloses an infrastructural technology, in the form of a generic agent architecture upon which domain-specific intelligent agents can be built and a distributed artificial intelligence platform upon which the intelligent agents can be deployed.

### SUMMARY OF THE INVENTION

The distributed artificial intelligence platform disclosed herein includes a very scalable distributed architecture capable of simultaneously running millions of context monitoring agents. The architecture has built-in support for fault tolerance in the face of software and hardware failures, and allows for the transparent resurrection of agents on different hosts if the server they are running on goes down, in a manner that is guaranteed to preserve semantic correctness.

Also included a general-purpose layered agent architectural framework, which includes core technology for reasoning, planning, optimization, constraint satisfaction, communication, workflow management, and learning. Using this framework, domain-specific technology can be easily embedded inside different kinds of agents. Equipped with the abilities provided by these core technology building-blocks, agents deployed on the platform will have the ability to define and fully participate in the next generation of intelligent distributed systems running on the semantic web.

### DETAILED DESCRIPTION OF THE DRAWINGS

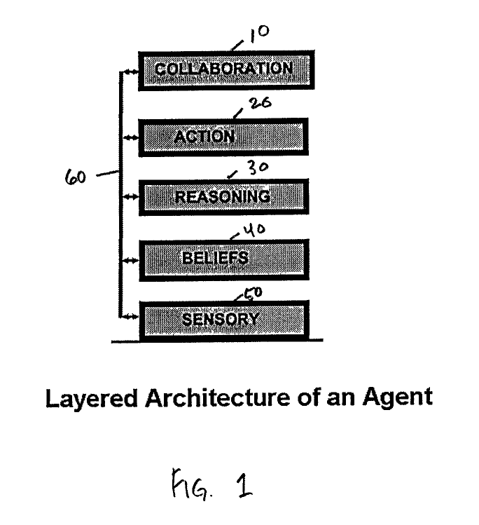

FIG. 1 shows the layered architecture of an intelligent agent according to this invention.

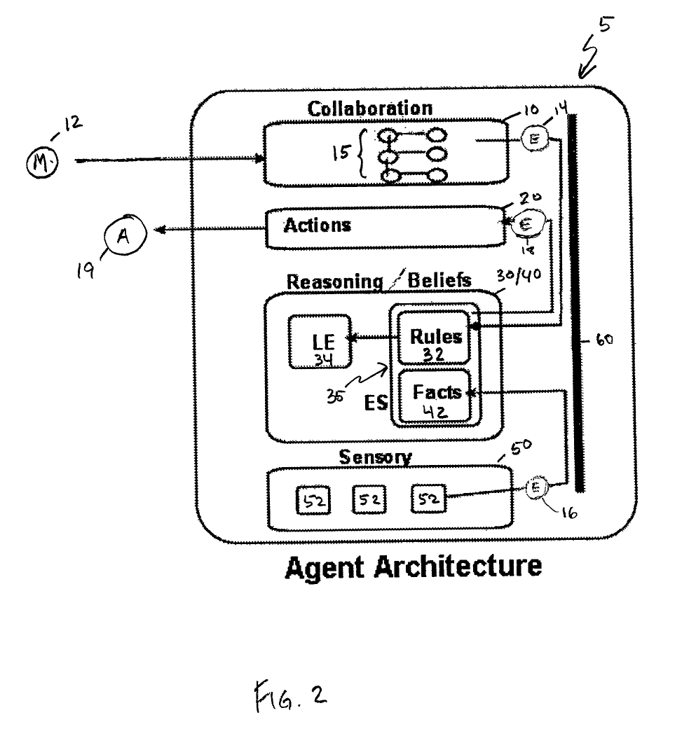

FIG. 2 shows a detailed architectural diagram of an agent, showing the movement of events and messages.

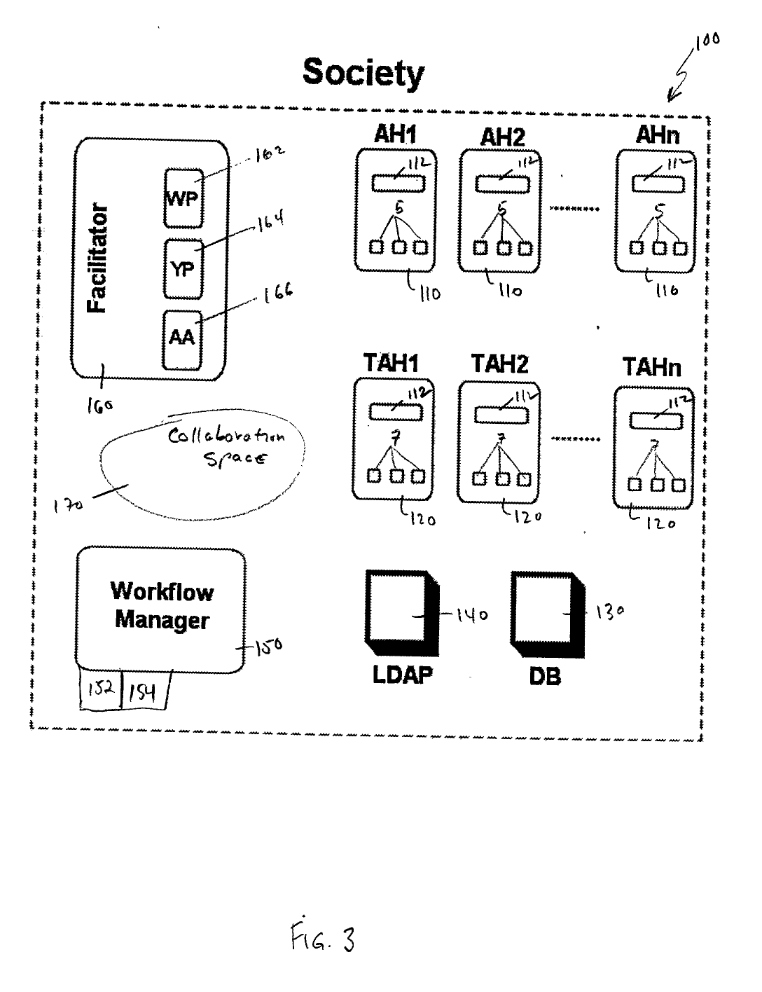

FIG. 3 shows the components of a distributed platform to support intelligent agents.

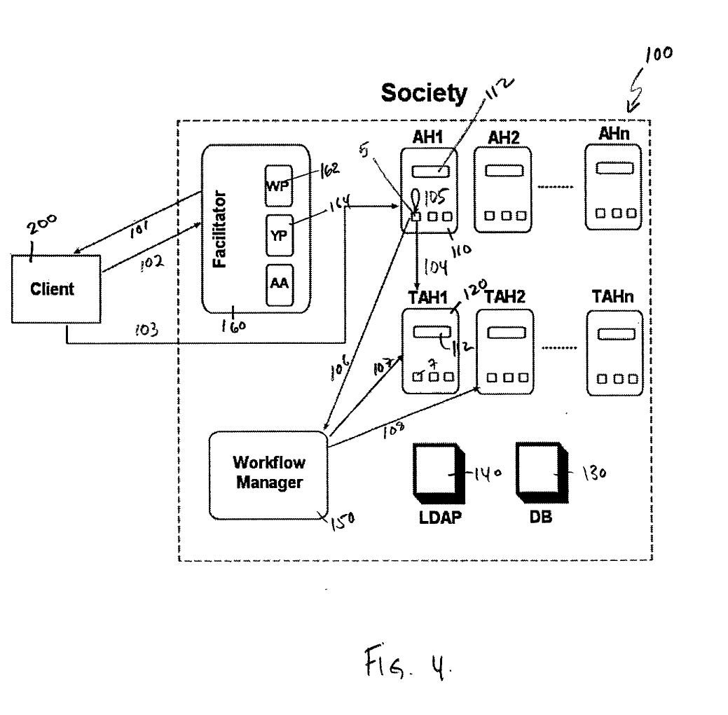

FIG. 4 shows the flow of data within the distributed platform.

### DETAILED DESCRIPTION OF THE INVENTION

The word agent is a heavily over-used one, and over the years many definitions have been given for the term. For purposes of this disclosure, we consider an agent to be a computer program having the characteristics of autonomy, reactivity, proactivity (goal-directed behavior) and social ability (communications with humans and other agents).

The basic distributed platform is modeled after the traditional notion of an operating system, which, provides, amongst other things, an interface over bare hardware. At the end user level, the operating system provides a friendly set of applications that make it possible for a user to productively use a complex piece of hardware without knowing a whole lot about it. At the programmer level, it provides a system call interface that makes it possible for a programmer to program complex operations without bothering about low level hardware details and without worrying about conflicts with other programs.

The distributed platform provides a similar interface over the semantic Web. This interface, too, works at two levels. At the end user level, it provides a set of intelligent web applications in different business domains that make it possible for users to tap into the information and services on the web. At the developer level, it provides a set of re-useable, pre-built agents and components that can be used to build intelligent web applications without a lot of effort, and without worrying too much about communications and artificial intelligence issues.

Agent Architecture

For an agent to exhibit the characteristics that we identified earlier, it needs to have certain essential capabilities. These include the ability to reason, the ability to plan, the ability to learn from its actions and the ability to communicate with other agents and information systems. The architecture disclosed herein enables the agents to have these characteristics.

FIG. 1 shows the layered architecture of a generic agent in the preferred embodiment. The architecture of an agent is complex, and an agent is capable of doing a variety of different tasks, at several levels of abstraction. For this purpose, an agent is decomposed into layers, so that a higher-level layer can use the behavior of a lower level layer.

The various layers of the agent architecture communicate with each other via events, which are published on event bus 60. Any layer of the architecture can publish events on bus 60 or read events from bus 60 and act upon them. When a layer receives some input in the form of an event, it processes it, and publishes the result of the processing as a new event on bus 60. Any layer interested in this new event is welcome to pick it up and do its own processing on the event. This interlayer, event-based communication between layers is asynchronous, and is designed to be capable of very high event throughput.

The collaboration layer 10 is responsible for handling incoming and outgoing messages. With respect to outgoing messages, collaboration layer 10 verifies and directs outgoing messages to other agents. With respect to incoming messages, collaboration layer 10 determines whether the agent is interested in the incoming message. Thus, collaboration layer 10 contains an interpreter 15 that is aware of the domain-specific language and ontology. As a result of the interpretation of the message, collaboration layer 10 may publish an event on event bus 60. As an example, with reference to FIG. 2, agent 5 receives message 12 containing a new rule that agent 4 needs to run. Collaboration layer 10 receives message 12 and hands it to interpreter 15 for decoding. The interpreter has an ontology handler that decodes the message and publishes a “New-Rule” event 14 on event bus 60.

Reasoning layer 30 and belief layer 40 are part of an expert system that is the core of the agent architecture. Although conceptually, reasoning and belief functions can be though of as separate, in reality, they together form part of a powerful expert system 35. As a result, we will often refer to them herein as “reasoning/belief layer 30/40”. Belief layer 40 comprises a collection of facts 42 in the working memory of expert system 35. Reasoning layer 30 comprises a database of rules 32 in the knowledge base of expert system 35 and the execution of the rules within the inference engine of expert system 35. In our example with the “New-Rule” event 14, reasoning layer 30 would read event 14 from event bus 60 and place the new rule contained in event 14 into the rule database 32 of expert system 35. Reasoning layer 30 also contains logic engine 34 which evaluates rules 32 based on facts 42.

Sensory layer 50 is responsible for monitoring the world outside of agent 5 and reporting changes in the environment to the other layers of the agent 5. To this end, sensory layer 50 will monitor sensors 52 and gather regular sensor updates. When a change is sensed, sensory layer 50 will publish a “New-Fact” event 16 on event bus 60.

Reasoning/belief layer 30/40 reads “New-Fact” event 16 from event bus 60 and will update fact database 42 with the new fact. This causes an evaluation of the rules with rules database 32 of expert system 35 that might fire because of the presence of this new fact. As part of this evaluation, calls are potentially made into logic engine 34 to check to see whether certain conditions hold. This feature gives each agent 5 access to not only the powerful and expressive logic-programming paradigm, but also to additional features such as constraint satisfaction and optimization. This allows reasoning layer 30 of agent 5 to be as complex and powerful as required for the particular function to be carried out by agent 5. And this can all be configured at run time, without any overhead for a simple agent that doesn't need all these features.

The action layer 20 of agent 5 is responsible for taking in pending actions and storing and carrying out actions required by agent 5. For example, the evaluation of the rules in rules database 32, based on facts stored in facts database 42 may require that agent 5 undertake a certain action. In this case, an “Action-Event” 18 is published on event bus 60 by reasoning/belief layer 30/40. Event 18 is picked up by action layer 20 from event bus 60 and the appropriate action 19 is carried out.

Logic engine 34 is the technology that provides core reasoning ability to an agent. Essentially, given a domain-specific ontology, the logic engine provides a very quick and easy way for an enterprise to become a participant in the domain/market defined by the ontology. All that needs to be done is to, first, import the ontology into logic engine 34, and, second, to define business rules stored in rules database 32 that embody the strategy of the enterprise.

Logic engine 34 provides support for a style of programming known as logic programming. Logic programming is based on ideas derived from the discipline of formal knowledge representation and reasoning. Formal logic is used to represent knowledge about specific domains, captured in the ontology for each specific domain, and to reason about things in these domains. It consists of the following:

A basic alphabet of symbols, which stand for things of interest in a domain.

Valid syntax, defined by a grammar, which describes how to make sentences from these symbols. These sentences state facts about the domain.

Semantics, which provides an interpretation for sentences i.e. how sentences relate to state of affairs in the domain.

Proof theory—made up of rules of inference for deducing new sentences from old ones.

A set of axioms that describe the known set of facts and rules about a domain.

A logic programming language is an embodiment of these ideas. It provides syntax and a proof theory for representing knowledge about a domain. The programmer specifies axioms describing the domain, and provides an interpretation for statement. Queries posed to the system are answered on the basis of the axioms by the application of the rules of inference of the system. Contrast this with the imperative programming, where the programmer specifies exactly what to do and when to do it.

One advantage of taking a logic programming approach to implementing domain-specific ontologies is that globally defined business rules can be imported as-is into the logic engine in an executable form. Another advantage is that rules specific to a business enterprise can be defined in a declarative fashion, which has advantages over any other method of defining business rules because of:

1. The high level of abstraction at which these rules are defined;

2. The ease with which business analysts can work these rules; and

3. The fact that these rules are executable.

Preferably, logic engine 34 is implemented as an interpreter for a dialect of Prolog that has been extended to give it the ability to reason about numbers and constraints/optimization-problems based on numbers. Most preferably, the logic engine is a pure Java implementation of a superset of Prolog. It features very good interoperability between the logic programming model and the well-known object oriented programming model, thereby allowing access to a wide range of Java application programming interfaces (APIs) from a logic program. This interoperability, for example, enables the access of multiple databases (through JDBC) in a single logic query. The logic engine has a very extensible architecture that allows the plugging-in of predicates written in Java. In fact, all the Prolog built-in predicates within the Logic Engine have been implemented as independent Java classes.

The logic engine also features a constraint satisfaction ability. This facilitates the efficient solving of a large class of numeric problems that would otherwise be difficult to solve based on just the Prolog programming model. Some of features of this subsystem may include:

Node, arc and bounds consistency based solvers for Finite Domain Constraints

A solver based on Integer Programming (branch and sound) for Finite-Domain Optimization problems

Support for Real-Domain constraints/optimization based on the Simplex method.

An important aspect of the distributed platform is the ability of agents to learn the best way to complete a given task. In our view, an agent is said to learn how to do a task based on the experience of doing that task, if some performance measure associated with the agent's doing the task improves as the agent gains more experience.

In computational terms, it is very important to decide on the exact nature of the knowledge that is to be learned by the agent. In general, it is useful to define an entity called the target function to represent the knowledge to be learned. The target function should be such that the process of learning the function leads to improved performance by the agent on the task under consideration. Given this conceptual framework, a machine learning algorithm can be said to consist of a target function that is learned and a way of learning this function from training data or experience

The framework disclosed herein contains implementations of the following:

Decision Trees, which can be used to learn discreet valued functions. We disclose a special kind of decision tree called an identification tree;

Neural Networks, which can be used to learn discreet valued or real valued functions; and

Reinforcement Learning, which is used for learning optimal control policies for an agent in an uncertain and non-deterministic environment.

What follows is a brief description of each of these algorithms.

Decision trees are used to classify data. The discreet valued function that is learned is a mapping from a set of attributes that characterize an instance of data to a category. A decision tree classifies an instance by sorting it down the tree from the root to a leaf node. Each node in the tree corresponds to a test on an attribute of the instance, and each branch descending from the node corresponds to one of the possible values of the attribute. The leaf nodes correspond to the different categories that define the possible classifications.

Once a decision tree is built, it is straightforward to convert it into a set of equivalent rules. We get a rule by tracing the path starting from a leaf node ending at the root node. By repeating this for all the leaf nodes a set of rules is obtained. After devising a rule set, useless rules must be eliminated. The question to be asked is: can any of the test outcomes be eliminated without changing what the rule does to the sample. If yes, it should be eliminated, thereby simplifying the rule set.

Preferably, the decision tree will have some means of reading training data from a relational database management system and a means of saving a decision tree in to a database.

Neural networks provide a powerful solution to the problems of both function approximation and classification. They have been used in a wide variety of tasks, ranging from character recognition to reinforcement learning action-value function approximation.

The implementation of the neural network for the distributed platform is preferably of the Multi-Layer-Perception type. This type of neural network has more than one layer of adaptable weights, and can be used to learn any kind of non-linear function.

The most important part in training a neural net is the weight update method, called back propagation. It helps search the most optimal configuration of the neural net. Preferably, the neural network component of the machine learning subsystem will have support for weight decay, support for use of momentum and support for variable search rates (e.g. RProp where the search rate automatically reduces if we are far from our goal and vice versa).

Reinforcement learning is concerned with the issue of how an agent, situated in an environment that it senses, and on which it acts, can learn an optimal control policy to achieve its goals. Or to be more precise, how an agent can learn to map situations to actions—so as to maximize a numerical reward signal. The agent is not told which actions to take, but instead must discover which actions yield the most reward by trying them. The target function that is learned here is something called the action-value function, and it assigns a numerical value to each action available in a state. Learning an optimal control policy boils down to learning the optimal action-value function.

In reinforcement learning, actions may affect not only the immediate reward, but also the next situation and, through that, all subsequent rewards. These two characteristics, trial-and-error search and delayed reward, are the two most important distinguishing features of reinforcement learning.

Reinforcement learning is defined not by characterizing learning algorithms, but by characterizing a learning problem. Any algorithm that is well suited to solving that problem can be considered a reinforcement learning algorithm. The basic idea is simply to capture the most important aspects of the real problem facing a learning agent interacting with its environment to achieve a goal. Clearly, such an agent must be able to sense the state of the environment to some extent and must be able to take actions that affect that state. The agent must also have a goal or goals relating to the state of the environment.

The job of a reinforcement learning agent is to maximize, over a given period of time, the numerical reward signal that it receives from the environment. However, it is impossible to write a single agent that solves all reinforcement learning problems. There are different kinds of environments, for example, finite or infinite, episodic or non-episodic, deterministic or non-deterministic, stationary or non-stationary. Depending on the nature of the environment, the agent must choose an optimal type of value function. So, for example, agents with tabular value-functions can interact only with finite environments. Similarly different kinds of planning agents would be appropriate for deterministic and non-deterministic environments.

A reinforcement learning agent must learn which action is good and which is bad by trial and error. Thus, an agent needs to completely explore all possibilities before deciding which one is the best. However, for optimal performance, it should always select the best action encountered so far. This inhibits explorations. A soft-max action selection criterion spares the agent this dilemma. However, there are many kinds of action selection methods, each of which may be suitable in a different kind of environment.

The most important aspect of a reinforcement learning agent is learning from the response of the environment (i.e. the reward signal). The agent compares the actual reward to the expected reward. Using these errors as a starting point, it learns and refines its policy using backup evaluation and credit assignment methods. Different agents may use different types of backup evaluation and credit assignment methods to achieve optimal performance.

Discussed herein are some aspects of the behavior of a reinforcement learning agent. After factoring in all of them, it should be obvious that hundreds of different agents may be needed for different scenarios. To overcome this problem we, have come up with a generic architecture that allows mixing and matching of capabilities. This enables custom-creation of an agent. Each aspect is characterized by a module, which can be implemented in several ways. Each one of the implementations may have their advantages and disadvantages. Moreover, different implementations may cater to different kind of problem. In a nutshell, this architecture supports a library of implementations of the various modules, which must be correctly chosen depending on the nature of the problem.

Typical modules include:

Action selectors: Boltzmann, Epsilon

Backup evaluators: TDSarsa, TDQ, TTD

Credit assigners: Waltkins, Eligibility Traces

Value Functions: Tabular, Linear, Non-Linear

Planner: DynaQ, DynaQ+, DynaAC, Prioritized Sweep

One obvious advantage of this architecture is that we can create an agent suitable for our needs by assembling the appropriate modules. Practically, this may be as easy as just writing a configuration file or assembling things with a few mouse clicks. Another advantage is that this architecture is extensible. A new planning algorithm, for example, can be added to the library of existing implementations and then can be used while assembling the agent without any modification to the rest of the reinforcement learning framework.

Distributed Platform Architecture

This invention also defines a distributed architecture for support of intelligent agents. Note that it is not necessary that the intelligent agent conform to the architecture above. An intelligent agent of any design can be supported by the distributed platform. For purposes of this disclosure, the distributed platform will be referred to as a “society.” The architecture for the society is composed of several logical elements, which will be discussed below. The society is physically supported by many hardware elements, including a plurality of computers and a communications network, such as the internet to interconnect the computers together

The society is a scaleable distributed architecture capable of simultaneously running millions of context monitoring agents. The society has build-in support for fault tolerance in the face of software and hardware failure and allows for the transparent resurrection of agents on different hosts if the server that they are running on goes down, in a manner that is guaranteed to preserve semantic correctness and context.

The society is capable of supporting three basic types of agents. These are entity agents, stateless task agents and stateful task agents. Entity agents generally represent entities that are interacting with the society, such as a physical user. These agents are generally very long lived and do context aware computation within the society. Generally the entity agents always need to be running because they need to continuously monitor the context for specific conditions. Entity agents are capable of surviving server crashes transparently to the client. One example of an entity agent would be a user agent that monitors a users location in the physical world to inform him of things of interest that are nearby. Physical users who register with the society will have an entity agent constantly running on their behalf, awaiting instructions from the user regarding a task to be carried out.

Stateful task agents carry out a specific, multi-step tasks for a client, which may require the recall of previous states or the results of previous steps as the steps of the task are executed. Thus, as state context is maintained between steps of the multi-step task. Stateful task agents typically expire when the task has been completed.

Stateless task agents are similar to stateful tasks agents except they do not retain a context and are generally useful for carrying out single step tasks, for example, the sending of an e-mail on behalf of a user. These agents are generally short lived and expire at the completion of the single step that they are instructed to carry out. Thus, no context needs to be retained within the stateless task agent.

Agent hosts 110 and 120 in the society are physical computers which house agents and manage their life cycles. Agent hosts also act as a message dispatcher for all agents living within it. Agent host 110 represents host capable of hosting entity agents while hosts 120 capable of hosting stateful and stateless task agents. It is useful to think of the agent hosts in this context because the entity and task agents are managed in different ways by the agent hosts. Therefore, some agent hosts are better suited to manage entity agents while other agent hosts are more suited to host task type agents. Typically in a society, there maybe dozens or hundreds of agent hosts. Typically, an agent host is a single physical computer able to communicate with other elements of the distributed platform via a communications network such as the internet.

Facilitator 160 facilities communication within the society. Facilitator 160 first and foremost provides a facade to the society with multiple high level helpful methods for dealing with agents and services running in the society. Any outside entity, such as a user monitoring agent which have been deployed on his behalf, can communicate to the society through the facilitator. The facilitator controls the agent activation protocol in the case of communications failure between a client of an agent and the agent host within which the client is running. Additionally, the facilitator houses servers for white pages 162, yellow pages 164 and agent activator 166. White pages server 162 provides information on specific agents and users, such as the address of the agent host where the agent is running, the agent's identifier, etc. Yellow page server 164 provides information about agents or sets of agents that provide services to the society. Agent activator 166 controls the agent activation protocol.

Workflow manager 150 controls the execution of multi-step tasks on behalf of the agents. The workflow manager itself is implemented as a stateful task agent that manages workflows within the system. The main components of the workflow subsystem are outlined below.

Within workflow manager 150 is process definition repository 152. It is a component of the workflow subsystem in which definitions of business processes are stored. These definitions are preferably in the form of XML documents in a global database, which allows for cross-enterprise operability. The repository is accessible over the network and allows different versions of the same process to be stored. In this way, changes can be made to the process definition without effecting processes that might already be running.

Workflow agent 154 is the heart of the workflow subsystem. It is responsible for running the workflows. It parses the process definitions, decides the tasks or task steps that are to be activated next, and sends out notifications when necessary.

Because the workflow manager 150 is a stateful task agent, it is running under a stateful task agent host 120. This host is responsible for managing the workflow agent's life cycle and also acts as a dispatcher for incoming messages addressed to the workflow manager.

There are task agents participating in the workflows being managed by the workflow manager. A workflow may be triggered by an external event (for example, in response to a 10% change in the cost of an airline ticket). A request to trigger the workflow must contain any relevant contextual information and the information regarding specific agents who shall participate in the process. Agents may be contacted by the workflow engine on the basis of their names (a lookup in white pages server 162) or on the basis of services they perform (a lookup in yellow pages server 164). A third way to contact the agents is by means of their agent identifier, which corresponds to a low level address as opposed to a name/service category-based lookup.

A workflow may involve several tasks being farmed out to a number of agents in parallel. Each agent asynchronously notifies the workflow engine when its assigned task has been completed. The agent then performs a dependency analysis to figure out if the workflow can proceed further and what new tasks need to be assigned.

Database 130 is a central repository of persistent information in the society. This information include such things as context rules for context aware agents and conversation information for stateful task agents. LDAP directory 140 is the central naming service in the system that houses administrative information such as user ids and user descriptions, agent ids and agent descriptions and host ids and host network endpoint descriptions. Agents are activated within the society via an agent activation protocol.

All network messages for an agent are sent to an entity called the message dispatcher, shown in FIG. 3 as 112 within each agent host 110, or 120. The message dispatcher in each agent host accepts messages for agents running on that host. Address for the agents are looked up from the society LDAP directory 140. Message dispatchers are implemented using a special kind of remote object that supports fault tolerance and load balancing capabilities. For this kind of remote object, stubs that are delivered to a client to enable remote calls are smart. If the stub detects a network failure that makes it impossible for the stub to communicate with its server-side message dispatcher, the stub, instead of returning an error to the client, instead forwards an agent activation request to agent activator 166 within facilitator 160. Facilitator 160, on receiving a request for agent activation, puts an activation request into a piece of distributed memory 170 called the collaboration space, that is shared amongst all entities in the society. Any one of agent hosts 110 or 120 running in the society can pick up the activation request from the collaboration space 170 and activate the agent 5 or 7. Once agent 5 or 7 is up and running the end point information for the agent's dispatcher is sent back to the stub running within the client process. The stub gets updated to point to this new location and a call is made to this new message dispatcher to forward the client's message to its agent. All this happens in a manner that is totally transparent to the client, through the use of the smart stub.

FIG. 4 illustrates the flow of messages within a society as a user client 200 interacts with the its entity agent 5. Client 200 may be any one of a variety of well known means of interacting with the society, such as a dedicated software tool or a browser. In step 101, the client queries facilitator 160 for the location of white pages server 162. In step 102, client 200 queries white pages server 162 through facilitator 160 to discover the location of agent 5. (i.e., what agent host the agent is running on). White pages server 162 will access LDAP directory 140 to get the latest information about agent 5. In step 103, client 200 sends a message to agent 5. The message is picked up by agent host 110 which is hosting agent 5. Message dispatcher 112 running in agent host 110 receives the message and routs it to agent 5. In step 104, a sensor within agent 5 fires and queries a task agent 7 for some sensory information. Message dispatcher 112 in task agent host 120 receives the message for task agent 7 and routes it to task agent 7. In step 105, the information received from task agent 7 is placed into the belief layer of agent 5, and, causing a re-evaluation of the rules in the expert system of agent 5. As a result of the re-evaluation of the rules in the expert system of agent 5, a workflow is initiated in step 106. In steps 107 and 108 , the workflow manager makes use of different stateful or stateless task agents to carry out the tasks in the workflow. This accomplishes whatever client 200 wanted to get done on by triggering of the context of interest.

As a real life example of the process flow shown in FIG. 4, consider that client 200 needs to go to the post office. He wishes to have a message delivered to his cellular telephone the next time he passes within five hundred yards of a post office as a reminder. To do this client 200 must author a rule to be sent to his entity agent. The rule is authored via an authoring tool on the desktop or via a tool or applet accessible through a web browser. Once client 200 has authored the rule, through whatever means is available, facilitator 160 is contacted to get the address of white pages server 162. White pages server 162 is then accessed to find on which agent host 110 client's agent 5 (an entity agent) is being hosted. This information is stored in LDAP 140. Client 200 sends the rule to agent host 110, which includes message dispatcher 112. Message dispatcher 112 will route the message to client's agent 5. The message is parsed by agent 5 as described earlier in the description of the agent architecture. In this case, the placement of the new rule in the expert system would cause an action to be taken by the client's agent 5, namely, the initiation of a workflow through a message to the workflow manager 150. Workflow manager 150 would consult yellow pages server 164 within facilitator 160 to find if there is a task agent running somewhere in the society which is capable of returning the location of a post office nearest to the location of client 200. It will also be necessary to constantly monitor the location of client 200, preferably through another task agent who is accessing a locator service over the Internet. This can be accomplished through a service which monitors the client's location through a GPS receiver located in the client's cellular telephone or by any other means that is well known in the art. Workflow manager 150 is constantly checking both the client's location and the location of the post office nearest to the client and returning this information to the client's entity agent 5. When it is determined that the locations are within five hundred yards of each other, entity agent 5 will initiate a stateless task agent that will send a message to client 200 by calling his cellular telephone. The task agent responsible for sending the message to the client's cell phone may be required to search the yellow pages to find a task agent or service that knows the number of client's cellular phone. Alternatively, this information may be provided in the rule authored by client 200. Once the client is notified of his proximity to the post office, the workflow is ended and the rule is removed from the expert system of client's entity agent 5.

Many such examples of services could be envisioned besides location based services. These could be things such as, requesting that your agent monitor the price of a stock of a certain company and send signals or messages to the client when the stocks price meets certain criteria or reminding the client of important dates, such as, anniversaries or birthdays, etc.

We have provided a general purpose architecture for both an intelligent agent and a distributed platform for the support of intelligent agents. The invention is not meant to be limited by the scope of the examples used, but is embodied in the claims which follow.

We claim:

1. An architecture for an intelligent agent comprising:
a messaging facility for handling incoming and outgoing messages;
an expert system for evaluating rules and maintaining known facts;
a sensory facility for sensing conditions external to said intelligent agent; and
a means for communication between said messaging facility, said expert system and said sensory facility.

2. The architecture of claim 1 wherein said means for communication comprises an event bus upon which events are published and from which said messaging facility, said expert system and said sensory facility can receive events.

3. The architecture of claim 2 wherein said messaging facility further comprises an interpreter for decoding incoming messages.

4. The architecture of claim 3 wherein said interpreter is aware of a domain-specific ontology.

5. The architecture of claim 4 wherein said interpreter may publish an event on said event bus in response to a decoded message.

6. The architecture of claim 2 wherein said messaging facility verifies and directs outgoing messages.

7. The architecture of claim 2 wherein said expert system further comprises:
a reasoning facility for storing and evaluating rules; and
a beliefs storage facility wherein known facts are stored.

8. The architecture of claim 7 wherein said known facts stored in said beliefs storage facility originate from a sensory input from said sensory facility.

9. The architecture of claim 7 wherein said known facts stored in said beliefs storage facility originate from a message received by said messaging facility.

10. The architecture of claim 7 wherein said known facts stored in said beliefs storage facility originate from an evaluation of a rule by said reasoning facility.

11. The architecture of claim 8 wherein said sensory facility publishes an event on said event bus noting a change external to said agent when such a change is detected.

12. The architecture of claim 11 wherein said event published by said sensory layer is received by said expert system said external change is stored in said beliefs storage facility.

13. The architecture of claim 7 wherein a change is said beliefs storage facility triggers a re-evaluation of said rules by said reasoning facility.

14. The architecture of claim 2 further comprising an action facility for carrying out actions required by said agent.

15. The architecture of claim 14 wherein said actions result from a re-evaluation of said rules by said reasoning facility.

16. The architecture of claim 14 wherein said actions result from an external condition sensed by said sensory facility.

17. The architecture of claim 7 further comprising a logic engine component to aid said reasoning facility in the evaluation of rules.

18. The architecture of claim 17 wherein said logic engine is aware of a domain-specific ontology.

19. The architecture of claim 18 wherein said logic engine is further aware of a set of axioms describing said domain.

20. The architecture of claim 19 wherein said logic engine has a constraint satisfaction capability.

21. The architecture of claim 20 wherein said logic engine enables said agent to learn optimal ways of solving certain problems or performing certain actions

22. The architecture of claim 21 wherein said logic engine learns via a decision tree.

23. The architecture of claim 21 wherein said logic engine learns via a neural network.

24. The architecture of claim 21 wherein said logic engine learns via reinforcement learning.

25. A society of intelligent agents comprising:
one or more agent hosts for executing agents;
a facilitator for enabling entities external to said society to communicate with and
discover information regarding entities within said society; and
a database containing information regarding all agents running in said society.

26. The society of claim 25 wherein all entities with said society are able to communicate via a communications network.

27. The society of claim 26 wherein said communications network is the Internet.

28. The society of claim 25 wherein said each of said agent hosts can host a plurality of said agents.

29. The society of claim 28 wherein each of said agent hosts further comprises a message dispatcher for routing messages to all of said agents hosted by that agent host.

30. The society of claim 25 wherein said database further comprises a white pages directory containing information necessary to identify, locate and send messages to a particular agent within the society.

31. The society of claim 30 wherein said database further comprises a yellow pages directory containing information regarding services available to agents running within the society.

32. The society of claim 25 further comprising a workflow manager for managing the execution of multi-step tasks.

33. The society of claim 32 wherein said workflow manager is capable of parsing multi-step task definitions and organizing the sequence of said steps necessary to complete the task described by said multi-step task definition.

34. The society of claim 33 wherein said workflow manager may use task agents to complete one or more of said steps of said task.

35. The society of claim 34 wherein said workflow manager can execute said steps of said task in parallel when appropriate.

36. The society of claim 35 wherein said workflow manager further comprises a task definition repository for storing said multi-step task definitions.

37. The society of claim 25 wherein said facilitator includes an agent activator responsible for instantiating agents.

38. The society of claim 37 wherein said agent activator is able to recover agents and their context which are no longer running due to software or hardware faults within said society.

39. The society of claim 37 wherein agents are activated by placing them in a distributed memory area accessible to all entities within said society.

40. The society of claim 39 wherein any one of said plurality of agent hosts within said society may remove an agent from said distributed memory and run said agent.

41. A society of intelligent agents comprising:
one or more agent hosts for executing agents;
a facilitator for enabling entities external to said society to communicate with and discover information regarding entities within said society; and
a database containing information regarding all agents running in said society;
wherein said intelligent agents comprise:
a messaging facility for handling incoming and outgoing messages;
an expert system for evaluating rules and maintaining known facts;
a sensory facility for sensing conditions external to said intelligent agent; and
a means for communication between said messaging facility, said expert system and said sensory facility.

42. The society of claim 41 wherein said society further comprises a workflow manager for managing the execution of multi-step tasks.

43. The society of claim 41 wherein said agents further comprise an action facility for carrying out actions required by said agent.
